(19) United States
(12) Patent Application Publication
(10) Pub. No.: US 2009/0151494 A1
(43) Pub. Date: Jun. 18, 2009

(54) Methods and Systems to Enhance Efficiency of Power-Transmission Systems Containing Higher Viscosity Lubricants

(76) Inventors: Clark V. Cooper, Arlington, VA (US); Joseph J. Sangiovanni, West Suffield, CT (US); Hongmei Wen, South Windsor, CT (US); Edward J. Karedes, Cheshire, CT (US)

Correspondence Address: PRATT & WHITNEY, 400 MAIN STREET, MAIL STOP: 132-13, EAST HARTFORD, CT, 06108, US

(21) Appl. No.: 12/084,602

(22) PCT Filed: Dec. 2, 2005
(86) PCT No.: PCT/US2005/043885

§ 371 Date: May 6, 2008

(51) Int. Cl. F16H 55/00; F16N 7/26; F01M 5/00; C10M 105/38; C10M 105/14; C10M 107/02; C10M 137/04; C10M 137/10

(52) U.S. Cl. 74/462; 184/13.1; 184/6.22; 508/501; 508/583; 508/591; 508/433; 508/370; 508/100; 508/108

(57) ABSTRACT

A power transmission system and a method for enhancing the efficiency of such systems are provided. The system and method includes a lubricant having a viscosity from about 0.01 centistokes to about 400.00 centistokes, power transmission components with a contact surface finish of less than about 16 microinches, and coating the power transmission components with the lubricant during operation of the system.

### BACKGROUND OF THE INVENTION

1. Field of the Invention

The present invention is related to transmission systems. More particularly, the present invention is related to the use of a high viscosity lubricant with components that have a superfinished surface to mitigate the parasitic energy losses that are normally seen in power transmission systems.

2. Description of Related Art

Mechanical systems such as manual or automatic transmissions; single and multi-speed aviation transmissions; push-belt type continuous variable transmissions; and traction drive continuous variable transmissions, have large surface areas of contact zones. These contact portions or zones, such as drive rolling surfaces, gears, ball-bearings and roller-bearings, are susceptible to high surface pressures. Moreover, the need for reducing friction, resistance, and fatigue within larger contact zones of mechanical systems is increased by many recently developed transmission systems that are designed to be miniaturized or weight-reduced to maximize transmission throughput capacity.

To alleviate the high surface pressures of contact zones, lubricants play a critical role in protecting and minimizing the wear and scuffing of surfaces. The lubricants generally reduce principal damage accumulation mechanisms of lubricated components caused by surface fatigue and overloading.

A lubricant is typically composed of a base stock and additives. Recently developed system-optimization approaches for increasing overall power throughput of mechanical systems, underscore the need for new and better performing lubricants. By reducing friction, wear, pressure and scoring resistance, these lubricants prolong surface fatigue life for lubricated contacts within transmission systems.

Lubricants with higher kinematic viscosities offer greater protection against wear and other degradation mechanisms inherent in mechanical components. However, as the viscosity of lubricants increases, in general there is an increase in the parasitic energy losses that are manifested as increased friction and heat generation. As friction and heat generation increase, the temperature of the lubricant also increases and the viscosity decreases. Consequently, the extent to which higher viscosity lubricants can be used to protect against wear is limited unless other means are provided to reduce these energy losses. These energy losses, therefore, narrow the range of temperatures over which the lubricants are useable. Accordingly, there is a need for a power transmission system and a method of transmitting power that reduces or mitigates parasitic energy losses.

### BRIEF SUMMARY OF THE INVENTION

The above-described drawback or disadvantage may be mitigated through the use of lubricants having higher kinematic viscosities in combination with components that have superfinished surfaces. These superfinished surfaces present less drag and, consequently, reduce associated parasitic energy losses. The combination of high viscosity lubricants and superfinished surfaces provides a number of advantages. For example, the temperature of the lubricant can be increased without sacrificing the required film strength resulting in a reduction of the amount of lubricant needed. This is also advantageous in that the size of the oil cooler required may be reduced. In some cases, the oil cooler may not be needed at all.

Another advantage is that a higher viscosity lubricant may be operable at a lower ambient temperature. This helps to alleviate the typical “cold-start” problem wherein there is a minimum starting temperature that must exist for a lubricant to be operable. It is also foreseen that a preheating device may be used in combination with the lubricant and the components to heat the lubricant prior to use. This would also help to make the lubricant operable in colder ambient temperatures.

By reducing the temperature at which the lubricant is operable, the size of any required heater can also be reduced. This will result in a decrease in energy consumption by the heater. Also, the time required to heat the lubricant to a temperature at which it can function may be reduced. Each of these temperatures will prove advantageous for equipment that is intended for use in colder climates. This equipment may include, but not be limited to, rotorcraft.

A further advantage of the use of a lubricant with a higher viscosity is that it can extend the high-temperature operational capacity and/or the maximum Hertzian contact stress of the gearbox components and systems. Higher viscosity lubricants offer greater film thickness and, in general, greater film strength than their lower-viscosity counterparts. Such thicker lubricant films result in greater separation distance between mating mechanical components, such as gears, bearings, or splines for a fixed contact stress or transmitting torque. Similarly, for constant conditions of temperature, speed, etc., such higher viscosity lubricants enable the transmission of higher torques and consequential higher Hertzian contact stresses between mated mechanical components relative to their lower viscosity counterparts for a given lubricant film thickness.

The use of a high viscosity lubricant with power transmission components that have a superfinished surface offers many advantages. Therefore, there is a need for a method of making power transmission systems that use such lubricants and surface finishes.

These and other advantages of the present invention are provided by a method of enhancing the efficiency of power transmission systems. The method includes finishing at least some contact surfaces of power transmission components to a surface finish of less than about 16 microinches, and coating these power transmission components with a lubricant having a viscosity from about 0.01 centistokes to about 400.00 centistokes during use of the power transmission system.

A system for transmitting power is also provided. The system includes power transmission components having at least some contact surfaces with a surface finish of less than about 16 microinches and a lubricant having a viscosity from about 0.01 centistokes to about 400.0 centistokes.

The above-described and other features and advantages of the present invention will be appreciated and understood by those skilled in the art from the following detailed description, drawings, and appended claims.

### BRIEF DESCRIPTION OF THE SEVERAL VIEWS OF THE DRAWINGS

FIG. 1 illustrates an exemplary embodiment of a method according to the present disclosure of producing a power transmission system.

FIG. 2 illustrates an exemplary embodiment of a system according to the present disclosure for transmitting power.

### DETAILED DESCRIPTION OF THE INVENTION

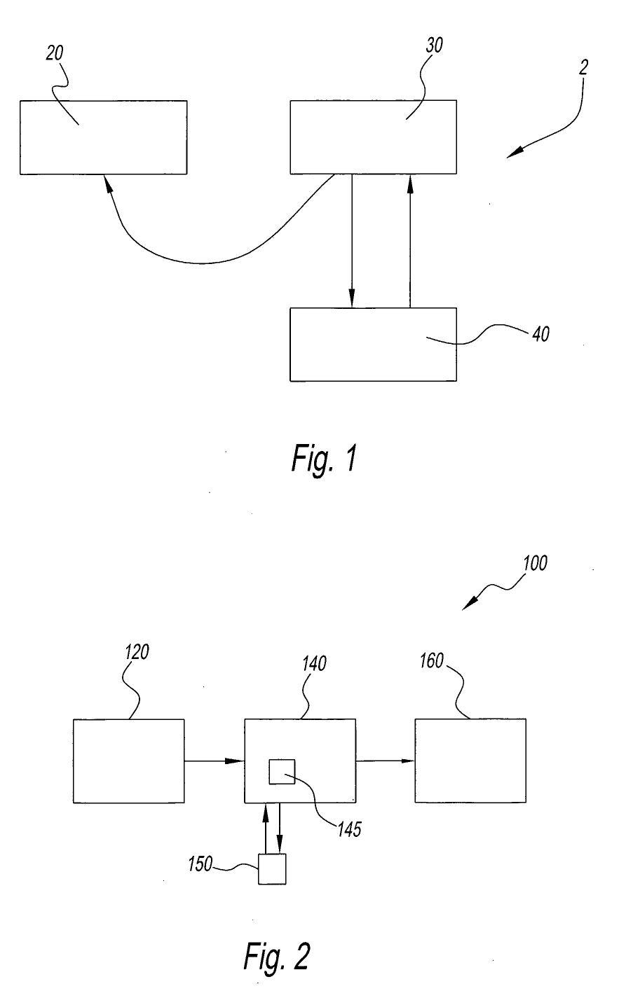

Referring to the drawings and in particular to FIG. 1, an exemplary embodiment of a method of producing a power transmission system is generally illustrated as reference numeral 2.

Method 2 includes the first step 20 of obtaining power transmission components 145. These components 145 may be, for example, intermeshing gears, bearings, springs, and/or splines, etc. At least some of the components 145 may be processed using a chemically accelerated vibratory finishing process to refine (reduce the roughness of) the contact surfaces of the components. According to this chemically accelerated vibratory finishing process, components composed of various metals and/or alloys may be placed into a processing hopper in the presence of processing chemicals and vibratory media. The chemicals are preferably selected such that they react with the metallic components that are being processed to form a soft metal-oxide that is removed, through interaction with the vibratory media, to expose an additional nascent metallic surface for further reaction to form oxide, which is then removed by the vibratory media. As this process continues, the height of the peaks that constitute the surface roughness of the contact surfaces is reduced until the desired surface roughness texture is achieved. The result is that at least some of these components 145 will have contact surfaces having a surface finish that is less than about 16 microinches and preferably less than about 3 microinches.

Some exemplary chemically accelerated vibratory finishing processes that can be used are described in more detail in U.S. Pat. Nos. 4,491,500 and 4,818,333 the contents of which are hereby incorporated in full by reference.

In the next step 30, a lubricant is obtained. The viscosity of the lubricant is preferably from about 0.01 centistokes to about 400 centistokes. In a preferred embodiment, the viscosity of the lubricant is from about 3 centistokes to about 12 centistokes.

The lubricant can be of various types. For example, the lubricant can either be natural or synthetic lubricant. Examples of natural lubricants include mineral oils, animal oil and vegetable oil, etc. The synthetic lubricants, on the other hand, can have various base stocks. For example, the base stock can be, but is not limited to, any of the following: polyol ester; polyalkylene glycol; aromatic naphthalene; alkyl benzenes; and polyalphaolefin, etc. The lubricant may also contain various types of additives to enhance the performance of the lubricant. For example, lubricant may contain anti-wear additives, such as tricresyl phosphate or zinc dialkyl dithiophosphate, which reduce scuffing and adhesive wear of transmission parts that are under high contact loads by forming a protective barrier film on contact surfaces.

In the next step 40, the lubricant is applied to the superfinished components 145 during operation of the transmission system utilizing any suitable lubricant delivery system, which can vary depending upon the gearbox configuration. Some embodiments may utilize mechanical pumps to enable pressurized delivery of the lubricant at a predetermined delivery pressure. In other embodiments, lubricant may be delivered through gravity, splash, or centrifugal means with no pump to aid or boost delivery. For example, in some pressurized systems, oil may be scavenged from either a “wet” or “dry” sump and pumped via mechanical lubrication pumps to the various parts of the gearbox for cooling as well as lubrication purposes. Such systems may have a mechanism to regulate the oil pressure and a filtration system to extract contamination particles. Also for example, some smaller gearboxes, such as an intermediate gearbox, may utilize a splash lubrication system whereby oil is splashed through the system via either a gear or a paddle system attached to the gear.

In some embodiments, the lubricant may be heated prior to use by a pre-heating device such as a heater 150. A suitable temperature range for pre-heating the lubricant prior to use could be from about 100 degrees Fahrenheit to about 200 degrees Fahrenheit.

Referring to FIG. 2, an exemplary embodiment of a power transmission system is schematically represented and generally referred to by reference numeral 100. System 100 has a power plant 120 that generates power or energy. The power is transmitted to a gearbox 140 for conversion as desired, such as, for example, direction, orientation and/or magnitude.

Gearbox 140 comprises various power transmission components 145, such as, for example, gears, bearings, springs and splines, etc., to facilitate conversion and transmission of the power. The power transmission components 145 are configured, such as, for example, intermeshing, to transmit the power to drive 160.

At least one of the power transmission components 145 has undergone a superfinishing process and has at least one superfinished contact surface of about 16 microinches or less thereon. A lubricant with a high viscosity, preferably from about 0.01 centistokes to about 400 centistokes, and more preferably from about 3 centistokes to about 12 centistokes, is supplied to the components 145. The high viscosity lubricant coats the surfaces, such as, for example, a gear tooth having a gear tooth profile with a face surface, which results in a reduction or mitigation of parasitic energy losses when the system is in operation and power is being transmitted. A heater 150 may be used to pre-heat the lubricant to facilitate the coating of the components 145 and the supply process.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A method for enhancing efficiency of power transmission systems, comprising:
finishing a contact surface of at least one of a plurality of power transmission components to a surface finish of less than about 16 microinches; and
coating said plurality of power transmission components with a lubricant having a viscosity from about 0.01 centistokes to about 400.00 centistokes during use of the power transmission system.

2. The method in accordance with claim 1, wherein at least one contact surface of at least one power transmission component has a surface finish of less than about 3 microinches.

3. The method in accordance with claim 1, wherein said plurality of power transmission components comprises at least one of: a gear, a bearing, a cam, a cam follower, a cone, a spring, a spline, and any combinations thereof.

4. The method in accordance with claim 1, wherein said plurality of power transmission components comprises a gear having a plurality of gear teeth.

5. The method in accordance with claim 4, wherein each one of said plurality of gear teeth define a gear tooth profile and a face surface.

6. The method in accordance with claim 1, wherein said lubricant comprises a polyol ester base.

7. The method in accordance with claim 6, wherein said lubricant comprises a viscosity of about 9 centistokes.

8. The method in accordance with claim 1, wherein said lubricant is a synthetic lubricant that is free of a base stock of polyol ester.

9. The method in accordance with claim 1, wherein said lubricant has a base stock that is selected from the group consisting of polyalkylene glycol, aromatic naphtalene, alkyl benzenes, polyalphaolefin, mineral oil, and any combinations thereof.

10. The method in accordance with claim 1, wherein said lubricant comprises an anti-wear additive.

11. The method in accordance with claim 10, wherein said anti-wear additive is selected from the group consisting of tricresyl phosphate and zinc dialkyl dithiophosphate.

12. The method in accordance with claim 1, wherein said lubricant has a viscosity of from about 3.0 centistokes to about 12.0 centistokes.

13. The method in accordance with claim 1, wherein said coating step comprises the use of a mechanical pump.

14. The method in accordance with claim 1, wherein said coating step comprises the use of a splash lubrication system.

15. The method in accordance with claim 1, further comprising heating said lubricant with a heater.

16. The method in accordance with claim 15, wherein said lubricant is heated to a temperature of between approximately 100 degrees Fahrenheit and approximately 200 degrees Fahrenheit.

17. A system for transmitting power, comprising:
a plurality of power transmission components having one or more contact surfaces with a surface finish of less than about 16 microinches; and
a lubricant having a viscosity of from about 0.01 centistokes to about 400.00 centistokes that coats at least a portion of said one or more contact surfaces.

18. The system in accordance with claim 17, wherein said plurality of power transmission components comprises at least one of: a gear, a bearing, a cam, a cam follower, a cone, a spring, a spline, and any combinations thereof.

19. The system in accordance with claim 17, wherein said plurality of power transmission components comprises a gear having a plurality of gear teeth.

20. The system in accordance with claim 19, wherein each one of said plurality of gear teeth define a gear tooth profile and a face surface.

21. The system in accordance with claim 17, wherein said lubricant comprises a polyol ester base.

22. The system in accordance with claim 21, wherein said lubricant comprises a viscosity of about 9 centistokes.

23. The system in accordance with claim 17, wherein said lubricant is a synthetic lubricant that is free of a base stock of polyol ester.

24. The system in accordance with claim 17, wherein said lubricant has a base stock that is selected from the group consisting of polyalkylene glycol, aromatic naphtalene, alkyl benzenes, polyalphaolefin, mineral oil, and any combinations thereof.

25. The system in accordance with claim 17, wherein said lubricant comprises an anti-wear additive.

26. The system in accordance with claim 25, wherein said anti-wear additive is selected from the group consisting of tricresyl phosphate and zinc dialkyl dithiophosphate.

27. The system in accordance with claim 17, wherein said lubricant has a viscosity of from about 3.0 centistokes to about 12.0 centistokes.

28. The system in accordance with claim 17, further comprising a mechanical pump adapted to deliver said lubricant onto said one or more contact surfaces.

29. The system in accordance with claim 17, further comprising a splash lubrication system adapted to deliver said lubricant onto said one or more contact surfaces.

30. The system in accordance with claim 17, further comprising a heater adapted to increase the temperature of said lubricant.
